(19) United States
(12) Patent Application Publication
(10) Pub. No.: US 2026/0242133 A1
(43) Pub. Date: Aug. 20, 2026

(54) STORAGE SYSTEM FOR ROLLED OR CYLINDRICAL PRODUCTS

(71) Applicant: STEELHOLDER LLC, Jacksonville, FL (US)

(72) Inventor: Igor Osokin, Volzhsky (RU)

(21) Appl. No.: 19/541,037

(22) Filed: Feb. 16, 2026

Related U.S. Application Data
(60) Provisional application No. 63/758,882, filed on Feb. 14, 2025.
(60) Provisional application No. 63/759,105, filed on Feb. 15, 2025.
(60) Provisional application No. 63/759,193, filed on Feb. 16, 2025.

(51) Int. Cl. B65G 1/02; B65G 1/04; B65G 13/12; B65G 57/06; B65G 57/11

(52) U.S. Cl. CPC B65G 1/02; B65G 1/0407; B65G 13/12; B65G 57/06; B65G 57/11; B65D 2519/00034; B65D 2519/00273

(57) ABSTRACT

A system for storing rolled or cylindrical products which includes at least two longitudinal guide beams configured to be installed on a supporting base surface and at least two transverse stop bars configured to be positioned onto and removably connected to the longitudinal guide beams. Each longitudinal guide beam includes multiple planks, each plank having a first end and a second end. The first end of the planks has a first toothed rack having a first pattern of grooves and projections at its bottom surface, and the second end has a second toothed rack having a second pattern of grooves and projections at its top surface. The second pattern is complementary to the first pattern allowing the first end of each plank to interlock with the second end of an adjacent plank to form a unitary longitudinal guide beam. Each transverse stop bar has a load bearing surface formed to incline at an acute angle with respect to a horizontal plane. The transverse stop bar also includes an internal transverse groove configured to be placed onto one of the longitudinal guide beams so as to secure the transverse stop bar on the longitudinal guide beam. The individual elements of the system, i.e., the longitudinal guide beams and transverse stop bars, are made of a rubber-polymer composite material having a high coefficient of friction.

### CROSS-REFERENCE TO RELATED APPLICATIONS

This application is a non-provisional application claiming all rights of priority to and incorporating by reference U.S. Provisional Patent Applications Nos. 63/758,882, filed on Feb. 14, 2025 (pending); 63/759,105, filed on Feb. 15, 2025 (pending); and 63/759,193, filed on Feb. 16, 2025 (pending).

### FIELD OF THE INVENTION

The invention generally relates to devices for storage and transportation of cylindrical, rolled products, such as rolls of sheet steel or pipes.

### BACKGROUND

Various devices for storing pipes are known in the art. One such device is disclosed in the patent for utility model, RU 127046 U1, published on Apr. 20, 2013. The disclosed device includes a base on which supports in the form of V-shaped prisms are placed. The bearing surface of the supports is made of a polyethylene-rubber composition containing 40±2% polyethylene and 60±2% rubber.

The disadvantages of this known pipe storage device include the inability to adjust the relative position of the support elements to accommodate the size and/or number of pipes placed on them. These devices can be used for a very limited range of pipe sizes. This range is determined by the distance between the supports, which is not adjustable.

Another device for storing pipes is known from the patent for utility model RU 114042 U1, published Mar. 10, 2012. This device includes connecting inserts and fashioned polymer blocks. Sector-shaped lodgement grooves alternating with intermediate flat sections are formed on one horizontal longitudinal surface of each of the blocks. The axes of the intermediate flat sections are perpendicular to the longitudinal axis of the respective fashioned polymer block. Radial grooves are made at the ends of the opposite horizontal longitudinal surface of each fashioned polymer block, and support pads complementary to the connecting inserts are formed at the bases of the sector-shaped lodgement grooves. Wherein, the axes of the support pads are perpendicular to the longitudinal axes of the fashioned polymer blocks and parallel to the axes of symmetry of the sector-shaped lodgement grooves.

One of the drawbacks of the above-disclosed pipe storage device is the inability to adjust the relative positions of the supporting and fixing elements to accommodate the size and/or number of pipes or other round objects placed on them. These devices can only be used for a limited range of pipe sizes, determined by the distance between the supports.

Another device for storing cylindrical products is disclosed in utility model patent RU 160971 U1, published Oct. 4, 2016. This known device contains a beam and multiple stops for holding the products in place. The beam has a U-shaped profile, the shelves of which have through-holes coaxially located with a certain pitch, made along the length of the beam. The stops are removable vertically installed elements with a thickness equal to the distance between the profile shelves and a height equal to at least two of these thicknesses. Similar holes are located in the base for installing fasteners when connecting to the beam and bevels on the working surface for interaction with the surface of the supported cylindrical products.

A disadvantage of the above device for storing cylindrical products is that to use the product, it is necessary to use studs, bolts or removable pins as fastening elements. This entails an increase in the number of structural elements and, as a consequence, an increased complexity and expense of the process of its assembly and operation. In addition, in structures using a fastening element (studs, bolts, removable pins), the load falls on the fastening element, which reduces their stability and reliability.

Finally, a device for storing pipes and rolled steel is known from the utility model patent RU 189183 U1, published May 15, 2019. This device includes a base and multiple removable stops. The base is a metal channel-shaped beam, inside of which a bar of rubber-composite material is installed. Gear racks are fixed on the side surfaces of the channel-shaped beam. The lower part of the removable stops is made in the form of gear racks with a pitch corresponding to the pitch of the gear racks of the channel-shaped beam.

The primary disadvantage of the above device is the lack of elasticity of the structure due to the nature of the material of the channel-shaped beam, which does not allow the device to be placed on an unprepared surface and to take the shape of the surface to ensure reliable stability of the supported rolls.

Accordingly, there is a need in the art for a compact and universal storage and transportation device for rolled, cylindrical products, which would allow for an easy and reliable assembly and disassembly even after repeated and long-term use, and which can be utilized for rolls of sheet steel of various diameters and weights, for example, from 650 to 2100 mm and weighing up to 30 tons, and in multiple tiers. In addition, there is a need for a device having elasticity and simultaneous strength, so as to ensure stability and safety of rolls on the device and to allow a user to store a large number of rolls.

### SUMMARY

In its general aspect, the invention is a system for storing rolled or cylindrical products which includes at least two longitudinal guide beams configured to be installed on a supporting base surface and at least two transverse stop bars configured to be positioned onto and removably connected to the longitudinal guide beams. Each longitudinal guide beam includes multiple planks, each plank having a first end and a second end. The first end of the planks has a first toothed rack having a first pattern of grooves and projections at its bottom surface, and the second end has a second toothed rack having a second pattern of grooves and projections at its top surface. The second pattern is complementary to the first pattern allowing the first end of each plank to interlock with the second end of an adjacent plank to form a unitary longitudinal guide beam. Each transverse stop bar has a load bearing surface formed to incline at an acute angle with respect to a horizontal plane. The transverse stop bar also includes an internal transverse groove configured to be placed onto one of the longitudinal guide beams so as to secure the transverse stop bar on the longitudinal guide beam. The individual elements of the system, i.e., the longitudinal guide beams and transverse stop bars, are made of a rubber-polymer composite material having a high coefficient of friction.

Another advantageous feature of this system is its mobility and versatility, the ability to compactly store the system elements and to quickly assemble it into working condition. No special skills or tools are required for its operation. Fastening of the system elements to the floor is not required.

The coiled steel storage system is designed for storing rolls of sheet steel with a diameter of 650 to 1500 mm (and even up to 2100 mm in some cases) and a weight of up to 30 tons, primarily in closed warehouses. The system allows storing rolls up to 3 tiers high. The system is designed for repeated and long-term use. The stability of the system is improved by connecting the longitudinal and transverse elements of the storage device using grooves. The ends of the longitudinal guide beams are equipped with ratchet locking sections (grooves and projections) to allow for expansion of the system by adding a desired number of longitudinal guide beams to accommodate a given number of rolled products.

Increased stability of the rolled products on the device is also achieved by constructing the longitudinal and transverse elements from a monolithic rubber-polymer composite material. This allows the rolled material to form a radial contact patch on the supporting surfaces of the bars during use due to deformation, which in turn increases the stability of the rolled material and allows for its original shape to be restored after the load is removed.

Rubber-polymer composite materials are a mixture of rubber and polymers in a specific proportion, which is then pressed into a mold. A product made from these materials, a monolithic structure without structural voids, provides the necessary stability, strength, and elasticity.

Despite the possibility of disassembly and adjustment, due to its design, the storage system of the present invention has the necessary rigidity and stability when assembled, due to the contact with the ground or other base of the entire area of the supporting surfaces of the device and the absence in the design of components that provide structural resistance to the mass of the roll without transferring the mass to the ground.

In accordance with another aspect of the present invention, the disclosed storage system is made of a monolithic rubber-polymer material with the necessary elasticity to restore its original shape after significant compression and to increase the contact patch during loading, which provides greater resistance to sliding and rolling forces and prevents roll shifting, rolling, and falling, thereby increasing roll stability. The monolithic nature of the material and the absence of voids, along with its elasticity, provide high strength, allowing the device to be used for storing heavy items. During use, the device was loaded with a 30-ton roll of sheet steel, which did not cause any damage during extended storage.

In the presented system, the displacement of the side stops is limited by friction at the junctions of the stop bars and the longitudinal guide beams, as well as by friction between the bottom surface of the stop bars and the surface of the storage platform. The proposed design is not damaged when supporting large-diameter rolls, even if the bottom of the roll rests on the longitudinal guide beams.

### BRIEF DESCRIPTION OF THE DRAWINGS

The invention is illustrated by way of examples which are not a limitation, and the figures of the accompanying drawings in which references denote corresponding parts, and in which:

FIG. 1 shows a general view of the storage system in accordance with the preferred embodiment of the present invention;

FIG. 2 shows an assembled view of the storage system in accordance with the preferred embodiment;

FIG. 3 shows longitudinal guide beams of the storage system;

FIG. 4 shows the preferred embodiment of the storage system with installed steel rolls;

FIG. 5 shows Table 1 listing technical parameters of the storage system of the preferred embodiment;

FIG. 6 shows another embodiment of the storage system with installed steel rolls;

FIG. 7 shows Table 2 listing technical parameters of the storage system of the embodiment shown in FIG. 6;

FIG. 8 shows a setup diagram for the storage system;

FIG. 9 shows an example of tying the outermost pairs of rolls of the lower tier of the assembled storage system;

FIG. 10 shows Table 3 listing technical parameters of the storage system for pipes;

FIG. 11 shows Table 4 listing technical parameters of the storage system for pipes;

FIG. 12 shows a setup diagram for the storage system for pipes;

FIG. 13 shows an example of tying the outermost pairs of pipes of the lower tier of the assembled storage system for pipes;

FIG. 14 shows individual elements of the storage system for pipes;

FIG. 15 shows the embodiment of the storage system for pipes with the pipes installed;

FIG. 16 shows another embodiment of the storage system for rolled products;

FIG. 17 shows a detailed view of the connection between individual elements of the system of FIG. 16;

FIG. 18 shows the embodiment of the storage system of FIG. 16 with an installed rolled product;

FIG. 19 shows Table 5 listing technical parameters of the embodiment of the storage system shown in FIG. 16;

FIG. 20 shows a setup diagram for the storage system of FIG. 16; and

FIG. 21 shows Table 6 listing technical parameters of the embodiment of the storage system shown in FIG. 16.

### DESCRIPTION

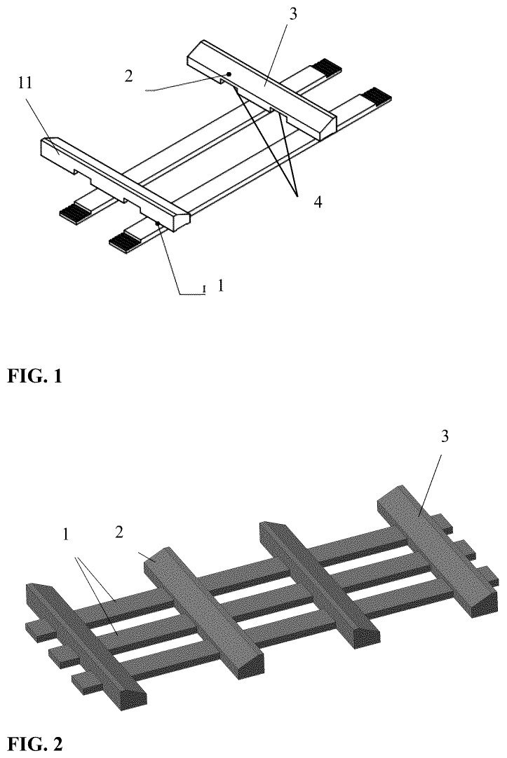

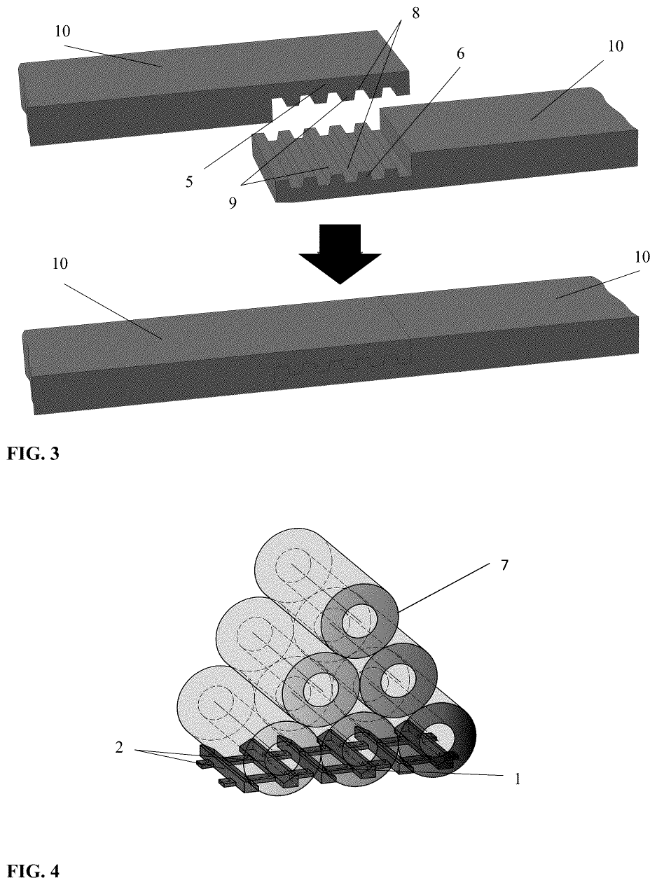

In accordance with the preferred embodiment, a rolled products (for example, steel rolls) storage system, generally shown in FIG. 1, includes longitudinal guide beams 1 and transverse stop bars 2 configured to be connected to the longitudinal guide beams 1. Each transverse stop bar 2 includes a load bearing surface 3 inclined at an acute angle to the horizontal plane (FIG. 1, 2). The acute angle of the load bearing surface enables the most secure positioning of the rolled products 7 on the assembled system, due to the fact that these load bearing surfaces inclined at an acute angle form the largest possible area of contact with the rounded surface of the products 7 (FIG. 3). Each transverse stop bar 2 also includes an outer wall 11 extending vertically from and substantially perpendicularly to the bottom surface of the stop bar.

The bottom surface of each transverse stop bar 2 is intended for connection with the longitudinal guide beams 1 and includes at least one transversely located groove 4 (FIG. 1). The number of grooves 4 in each stop bar 2 depends on the number of longitudinal guide beams utilized by a particular individual system. In general, the quantity of these elements in each system is individually determined in accordance with a user's specification. In the preferred embodiment shown in FIGS. 1-2, the inventive system preferably includes two (FIG. 1) or three (FIG. 2) longitudinal guide beams, depending on the requirements for the system's supporting capacity. Consequently, each transverse stop bar 2 of FIG. 1 includes two grooves 4, and each transverse stop bar 2 of FIG. 2 includes three groves 4.

Each groove 4 has a depth substantially equal to the height of the longitudinal guide beam on which the stop bar is placed. Thus, the overall design of the assembled system allows the entire bottom area of the guide beams 1 and stop bars 2 to rest on the ground or any other supporting surface, thus enabling greater support and stability of the entire system.

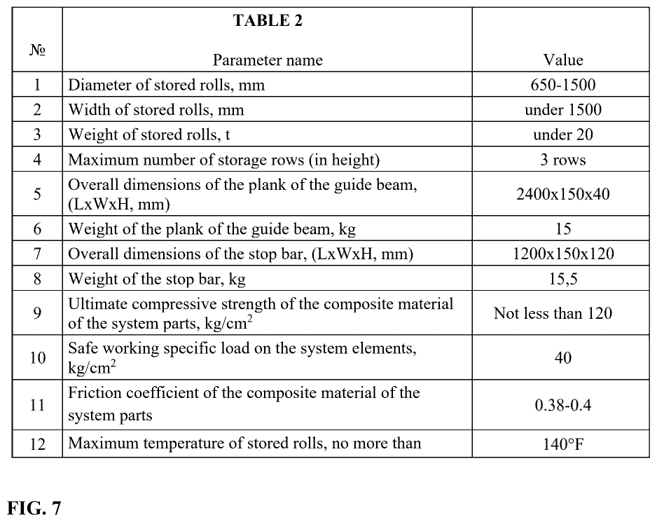

As shown in FIG. 3, each longitudinal guide beam 1 comprises a plurality of planks 10 assembled together into a singular guide beam. Each plank 10 preferably includes a first end 5 and a second end 6, each comprising a toothed rack. Specifically, the first end 5 preferably includes the toothed rack having a pattern of grooves 8 and projections 9 at its bottom surface, and the second end 6 includes the toothed rack having a complementary pattern of grooves 8 and projections 9 at its top surface. As shown in FIG. 3, the ends of adjacent planks 10 of the longitudinal beam 1 can be interconnected and interlocked by inserting projections 9 of the first end 5 of one plank into the corresponding grooves 8 of the second end 6 of the adjacent plank, elongating the guide beam to a desired length, consequently, extending the entire storage system to a desired dimension. Exemplary dimensions and technical specifications of the preferred embodiment of the storage system are shown in Table 2 (FIG. 7).

Longitudinal beams 1 and transverse stop bars 2 are made of a rubber-polymer composite material, without internal voids and cavities. The design of the device parts without internal voids and cavities gives the product the necessary stability and reliability, which, in accordance with empirical studies, allows for loads weighing up to 30 tons to be placed on the device. The rubber-composite polymer material for longitudinal planks 1 and transverse beams 2 is made from a mixture of crushed rubber and polymer raw materials (crumbs) by monolithic pressing in special forms under high pressure at high temperatures. The resulting monolithic product has the required stability and a very high coefficient of friction. Specific coefficients of friction for each embodiment are shown in Tables 2, 3 and 5 of the present application. (FIGS. 7, 10 and 19). Design and operating principle.

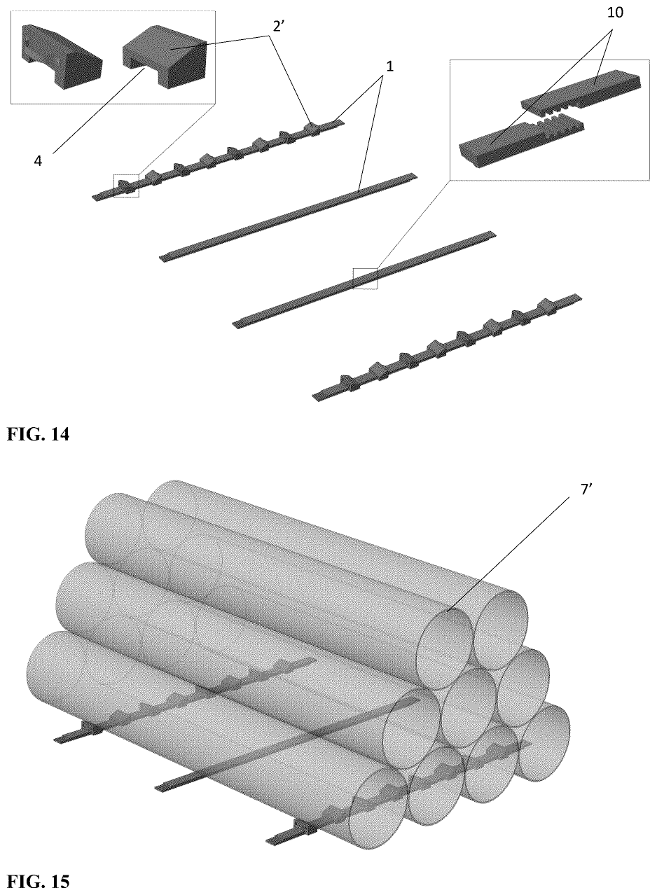

As shown in FIGS. 4 and 6, the storage system of the preferred embodiment is a collapsible structure which includes two or three parallel rows of longitudinal guide beams 1 that bear the main load of the stored rolled products, and transverse stop bars 2 installed on them, which prevent the rolled products from rolling off the guide beams. The guide beams are preferably placed directly onto the warehouse floor (or any other similar supporting surface), and the stop bars are placed directly on and across the guide rails such that the entire width of the guide beam is inserted into corresponding grooves 4 of each stop bar 2, thus ensuring that stop bars 2 are securely mounted on the guide beams 1. To move the stop bars during installation and readjustment of the system, they can include soft handles (shown, for example in the embodiment of FIG. 14). As disclosed above, the guide beams and stop bars are made of a polymer composite material, which has high strength characteristics and a friction coefficient of 0.38-0.4. Thus, the storage system of the preferred embodiment ensures high stability and reliability of storage and meets all the requirements of the majority of warehouse sites for storing rolled steel around the world.

The length of the roll storage area is determined based on the condition of a multiple of the length of one bar and can be any value required by the user.

Assembly of the system should be conducted at the location where the rolled products will be stored. A clean, level surface with a hard surface should be selected as the support surface. It should be noted that use of any antifriction liquids (fuel, oil) on the support surface should be avoided. In winter, open surfaces must be cleared of snow and ice.

To assemble the guide beams, individual planks of the required length are connected to each other by interlocking the ends of each plank, as described above and shown in FIG. 3. In the preferred embodiment, the length of each locking portion of the plank is preferably 140 mm. For greater reliability, the locking portions of the planks can also be fastened together by self-tapping screws (not shown), sinking their heads by approximately 5 mm.

In the preferred embodiment, there is no fixation between the stop bars and the planks assembled into the guide rails because the composite material from which the system elements are made has a high coefficient of friction, which ensures stable and reliable operation of the system subject to all assembly, installation and adjustment requirements (primarily to the floor surface). The required characteristics of the composite material are specified in Table 2 (FIG. 7).

### Assembly and Operation.

The storage system of the present invention is easy to install, and does not require any specialized tools or personnel qualifications. Installation can be carried out even by a single user.

The system elements should be laid on a planned and clean area with a hard surface (concrete, asphalt), the design strength of which corresponds to the weight of the stored rolls. The deviation of the surface of the area from the horizontal plane in the longitudinal and transverse directions should be no more than ±1°, there should also be no local irregularities (pits, bumps) on the floor. Any presence of liquids with antifriction properties (fuel, oil) on the surface of the area should be avoided.

The method of assembling a section of the system is carried out in the following sequence. First, for the ease of installation of the system, a user should preferably draw a straight line (with chalk or paint) on the surface of the platform or stretch a cord along which one of the rows of guide beams will be placed. Next, the first row of individual planks of the first guide beam should be laid out along this auxiliary line, which will preferably be one of the outer guide beams of the assembled system. Then, parallel to the first row, the remaining rows of guide beams should be laid out at a distance equal to the distance between the grooves on the applied stop bars. Next, based on the diameter of the stored rolls D, the user should select a suitable distance A between the outer walls of each pair of transverse stop bars 2, according to the values in Table 1, FIG. 4, and install the transverse stop bars 2 on the longitudinal guide beams 1 by placing an appropriate portion of each longitudinal guide beam into a corresponding groove 4 of the stop bar and making sure that the load bearing surfaces of each pair of the transverse stop bars face each other. Each pair of adjacent stop bars 2 thus forms a storage cavity for placement of the first row of the rolled products. Next, the rolled products can be stacked on the assembled system in the manner shown in the figures.

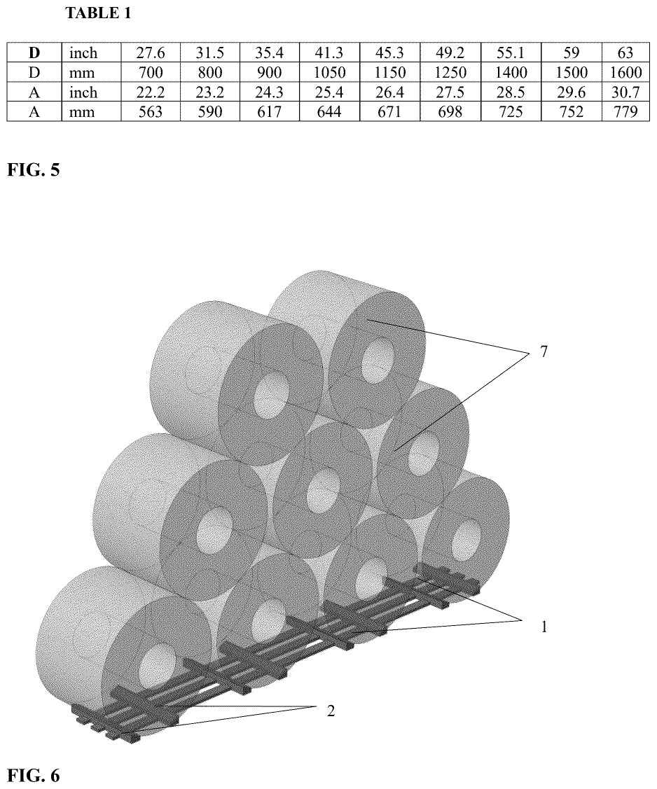

FIG. 8 shows a setup diagram for the storage system of the first two preferred embodiments of the present invention. As shown in FIG. 8, D is the diameter of the stored roll, mm, and is 650≤D≤1700; C is the recommended distance between rolls in one row, mm, and is 0≤C≤100; A is the distance between the bars holding the roll, mm, and A=0.22D+410; and B is the distance between pairs of holding bars, mm, and B=D+C. In accordance with the first preferred embodiment of FIGS. 1-5, the distance B between the pairs of holding transverse stop bars 2 equals the diameter D of the stored rolls, and the distance A between the stop bars 2 holding the roll is selected from Table 1, FIG. 5.

While the first preferred embodiment of the present invention discloses a storage system in which rolled products are stored immediately adjacent to each other, i.e. distance C=0, other variations are possible, as for example is shown in FIGS. 6, 8 and 9. Further, readjusting the system to a different diameter of the stored rolls comes down to rearranging the stop bars at different intervals, according to the adjustment recommendations.

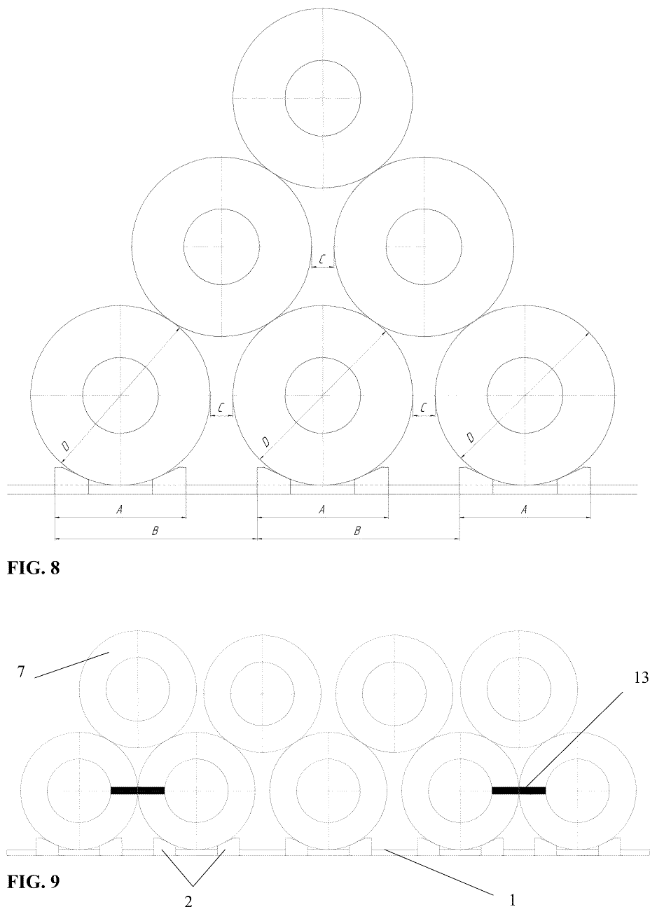

To ensure safe operation of the system during multi-row storage, the two outer rolled products on each side of the lower tier can be tied into one load space, as shown in FIGS. 9 and 13. Such tied connection can be accomplished, for example, with a ratcheted tying strap 12 or a bracket 13.

During operation, the guide rails may be deformed under the weight of the rolls, forming a radius contact patch, which contributes to greater stability of the rolls. After removing the load, there may be minor residual deformation in the areas of contact with the roll, which is not a defect and does not affect the operational properties of the storage system. In accordance with a conducted empirical analysis, the material of the present system easily restores to its original dimensions after deformation.

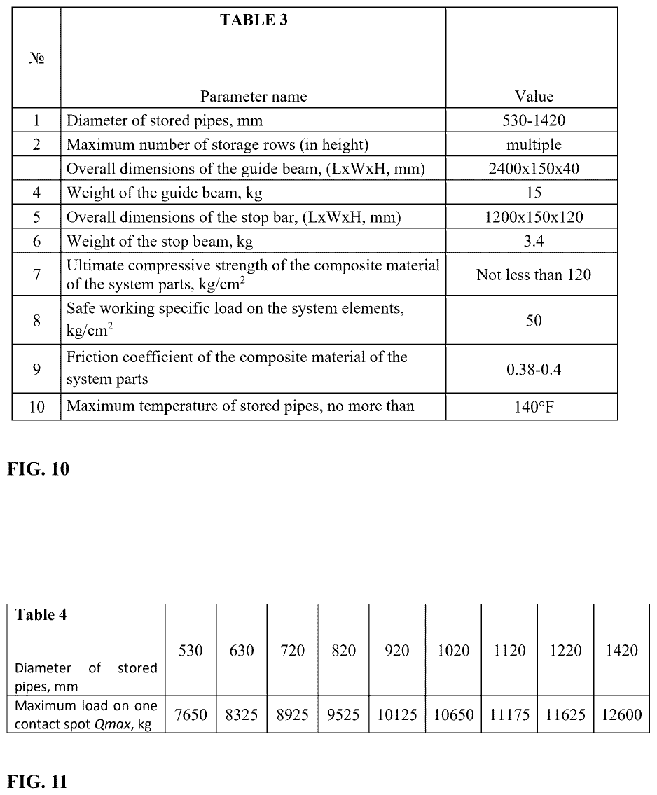

The storage system disclosed above can be easily adopted for storage of elongated rolled products, for example, large diameter pipes 7′, as shown in FIGS. 10-15. In this embodiment, as shown in FIGS. 14-15, the storage system is a collapsible structure comprising several parallel rows of guide beams 1, that bear the main load of the stored pipes, and shortened stop bars 2′ installed on the guide beams 1, the stop bars 2′ being positioned to prevent the pipes from rolling off. Similarly to the above-disclosed preferred embodiment, each stop bar 2′ includes a transverse groove 4 sized to fit onto the guide beam 1. In use, the guide beams are placed on the warehouse floor, and the stops are placed directly on the guide beams. Regardless of the number of rows of guides, the stop bars 2′ are preferably installed only on the outer ones, i.e. four stop bars for each pipe. Soft handles are preferably provided for moving the stop bars during installation and readjustment of the system. The guide beams and stop bars are made of a polymer composite material, which has high strength characteristics and a friction coefficient of 0.38-0.4.

The assembly of this alternative embodiment of the storage system is performed in essentially the same manner as discussed above with respect to the first preferred embodiment. Prior to the assembly, based on the weight of the stored pipe and the number of storage rows, the number of rows of guide beams is determined using the formula:

$$N = \frac{m \times n}{{Q}_{max}}$$

where: m is the weight of one pipe of the planned stack, kg; n is the number of rows in the planned stack, pcs.; and Qmax is the maximum load on one contact patch with the guide beam for the selected pipe diameter, kg (selected in accordance with Table 4, FIG. 11). The obtained value Nis rounded up to the nearest higher value, but not less than 3. If the required diameter is not found in the table, the Qmax value for the nearest smallest diameter should be selected.

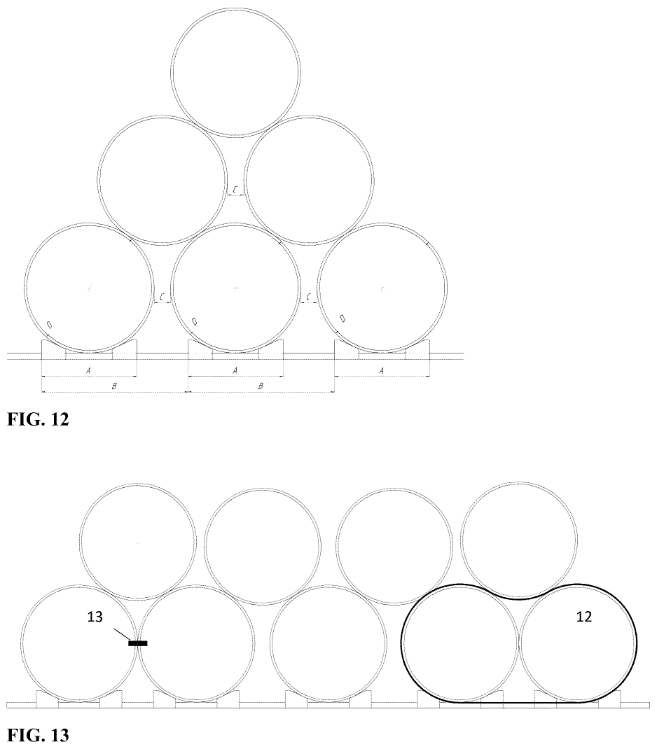

Installation of this embodiment of the storage system can also be carried out in the manner similar to the process of installation of the system of the first preferred embodiment. Specifically, the user will first draw a straight line (with chalk or paint) on the desired supporting surface or stretch a line along which one of the rows of the guide beams will be placed. The first row of guide beams can then be laid out along this auxiliary line. When the installation is finished, this first row will be one of the outer rows of guide beams. The remaining rows of guide beams are then laid out parallel to the first row at equal distances from each other. The distance between the outer rows of guide beams is assigned as a value equal to the difference between the length of the pipe and the distance by which the ends of the pipe should protrude beyond the outer rows of the guide beams. Based on the diameter of the stored pipes, shortened stop bars 2′ on the outer rows of guide beams 1 are then installed according to the diagram shown in FIG. 12, where, D is the diameter of the stored pipe, mm, and 530≤D≤1420; C is the recommended distance between pipes in one row, mm, and 0≤C≤50; A is the distance between stop bars supporting the pipe, mm, and A=0.22D+410; and B is the distance between pairs of holding stop bars, mm, and B=D+C. Next, the pipes are laid out on their designated stop bars and across the guide beams.

The system can be reconfigured as necessary. Reconfiguring the system to a different diameter of stored pipes comes down to rearranging the stop bars at other intervals in accordance with adjustment recommendations.

Similarly to the above embodiments, to ensure safe operation of the system during multi-tier storage two outer pipes on each side of the lower tier can be secured into one load space, as shown in FIG. 13. This can be accomplished, for example, with a ratchet strap 12, a tied connection, and/or clamps or brackets 13 secured at both ends of the pipes.

During operation, the guide beams can get deformed under the weight of the pipes, forming a radius contact patch, which contributes to greater stability of the pipes. After removing the load, there may be minor residual deformations at the places of contact with the pipe, which is not a defect and does not affect the operational properties of the storage system.

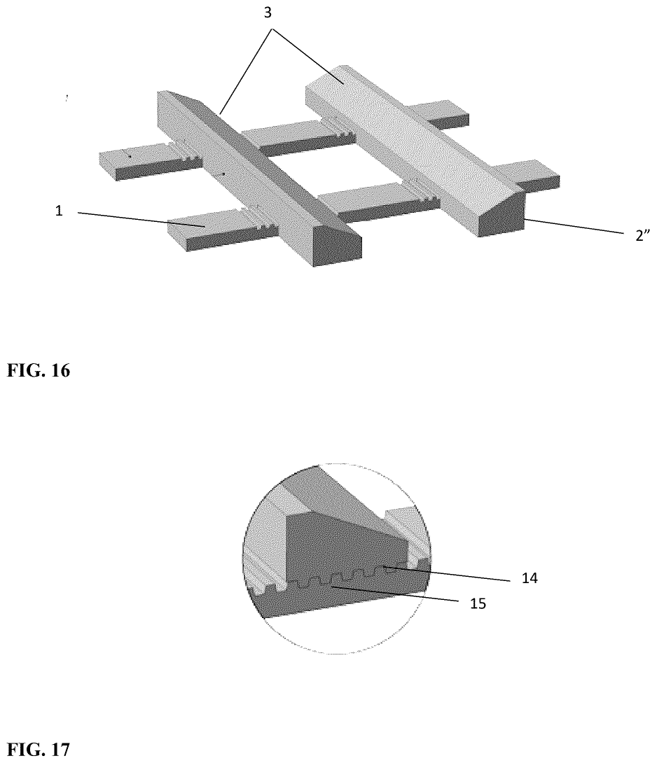

A further embodiment of the inventive system is shown in FIGS. 16-21. In this embodiment, the storage system is constructed as a pallet comprising two guide beams 1, each having a preferred size of 40×150×1200 (mm); and two stop bars 2″, each having a preferred size of 120×150×1200 (mm).

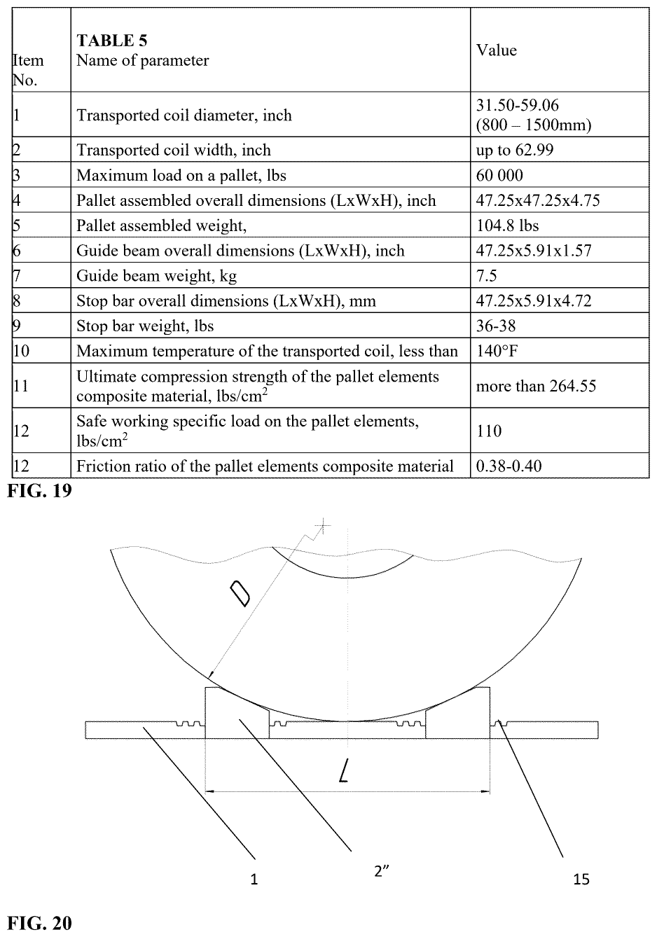

As shown in FIG. 16, the pallet is a relocatable construction comprising two guide beams 1, each having a preferred cross-sectional dimension of 40×150 mm, and two stop bars 2″, having a preferred cross-sectional dimension of 120×150 mm, perpendicularly mounted on the guide beams 1. Each stop bar 2″ includes a supporting surface 3, which is preferably inclined at an angle of approximately 25° with respect to the bottom surface. Locks in the form of interlocking portions 14 and 15 having complementary teeth are provided to fasten the stop bars to the guide beams. The length of the interlocking portion 15 of each guide beam is preferably longer than the width of the stop bar 2″ allowing the user to install the stop bars at various distances from each other and, accordingly, to place and support rolled products of different diameters. Soft handles (similar to the ones shown in FIG. 14) can be provided to relocate the stop bars during assembling or readjustment of the pallet. The total load (coil weight) of the rolled products installed on the pallet is equally distributed on all of its elements. The guide beams and stop bars of the pallet are made of a polymer composite material, which has high strength characteristics and a preferred friction coefficient of 0.38-0.4. Other technical characteristics of the pallet are shown in Table 5, FIG. 19.

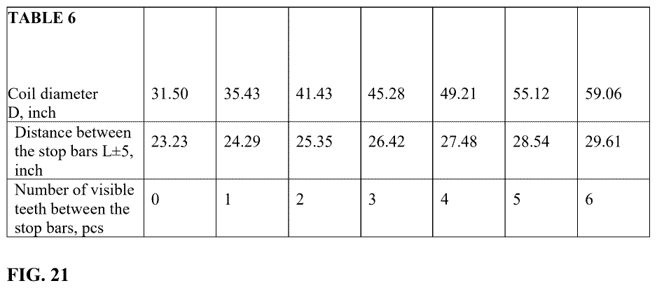

The disclosed pallet is preferably assembled by first placing the guide beams 1 with their interlocking portions 15 in an upward position in parallel onto a supporting site surface (e.g., a warehouse floor, a flatbed of a track or a platform) at approximately 106 cm from each other and aligning their faces in one plane. Using Table 6 of FIG. 21, the user will then select installment parameters for the desired diameter of the coil to be supported and the distance between the stop bars. Stop bars 2″ are then installed on the interlocking portions 15 of the guide beams 1 at the distance specified in Table 6. This process should preferably be followed by verifying proper and complete interlocking between the elements. If all elements are installed properly, the bottom surface of each stop bar is positioned flat against the supporting site surface.

To properly select the distance between the stop bars 2″ from Table 6 where the actual diameter does not exactly correspond to the dimensions specified in Table 6, the user should select a nearest bigger value than the actual diameter. For ease of adjustment, Table 6 also provides installment information by the number of the teeth (protrusions) of the interlocking portion 15 visible between the pair of the supporting stop bars 2″ (assuming the teeth of interlocking portions 14 and 15 having standardized dimensions). For example, FIG. 20 shows three teeth between the pair of the stop bars 2″.

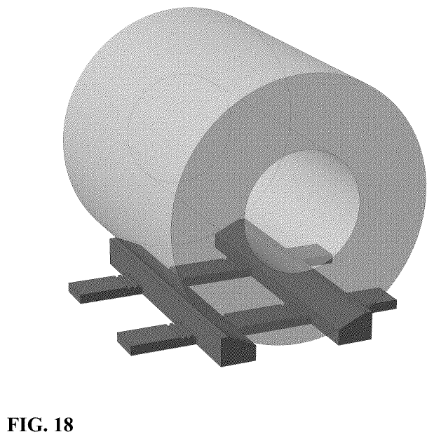

To ensure proper adjustment and symmetrical installation of the stop bars with respect to the middle of the guide beams, the difference between the number of beam teeth visible between the stop bars should not be more than 1 tooth. It will ensure positioning of the rolled product's contact spot exactly in the middle of the guide beam and will eliminate deformation in case of displacement to either side. The final step in the process is to install the rolled product (e.g., a steel coil) on the pallet. The resulting assembly is shown in FIG. 18.

During operation, the guide beams may deform under the weight of the coil forming a radial contact spot, which contributes to greater stability of the coil. After removing the load, residual deformation is likely to be found in places of contact with a coil, which is not a defect and will not affect the operational properties of the pallet.

In the preceding specification, the invention has been described with reference to specific exemplary embodiments thereof. It will however, be evident that various modifications and changes may be made thereto without departing from the broader spirit and scope of the invention as set forth in the claims that follow. For example, even though the system disclosed herein is described as a “storage system,” it should be understood by a person skilled in the art that the system can also be used for transporting rolled or cylindrical products or for other similar purposes. The specification and drawings are accordingly to be regarded in an illustrative manner rather than a restrictive sense.

We claim as follows:

1. A system for storing rolled products, the system comprising:
at least two longitudinal guide beams configured to be installed on a supporting base surface, each longitudinal guide beam further comprising a plurality of planks, each plank having a first end and a second end, the first end including a first toothed rack having a first pattern of grooves and projections at its bottom surface, and the second end including a second toothed rack having a second pattern of grooves and projections at its top surface, said second pattern being complementary to said first pattern, the first end of each plank being configured to interlock with the second end of an adjacent plank to form a unitary longitudinal guide beam; and
at least two transverse stop bars configured to be positioned onto and removably connected to the longitudinal guide beams, each transverse stop bar having a load bearing surface formed to incline at an acute angle with respect to a horizontal plane, each transverse stop bar further including an internal transverse groove configured to be placed onto one of said longitudinal guide beams so as to secure said transverse stop bar on said longitudinal guide beam,
wherein the longitudinal guide beams and transverse stop bars are made of a rubber-polymer composite material having a high coefficient of friction.

2. The system for storing rolled products according to claim 1, wherein, when said transverse stop bars are installed on said longitudinal guide beams, a pair of adjacent transverse stop bars form a storage cavity for the rolled products to be placed into, said longitudinal guide beams within said storage cavity bearing most of a load of said rolled products and said transverse stop bars preventing said rolled products from rolling off said system.

3. The system for storing rolled products according to claim 2, wherein, when said transverse stop bars are installed on said longitudinal guide beams, said load bearing surfaces of said adjacent pair of transverse stop bars face each other so as to partially surround an outside surface of a rolled product placed into said storage cavity.

4. The system for storing rolled products according to claim 1, wherein each of said longitudinal guide beams further includes a bottom surface, wherein each of said transverse stop bars further includes a bottom surface, and wherein, when said transverse stop bars are installed on said longitudinal guide beams, said bottom surfaces of said longitudinal guide beams and said bottom surfaces of said transverse stop bars form a unitary and leveled system bottom surface.

5. The system for storing rolled products according to claim 1, wherein said system is configured to support and store rolled products having a diameter of 650-1500 mm.

6. The system for storing rolled products according to claim 1, further comprising a tying element tying at least two of rolled products supported by said system.

7. The system for storing rolled products according to claim 1, wherein said high coefficient of friction is 0.38-0.4.

8. A system for storing cylindrical products, the system comprising:
at least one longitudinal guide beam configured to be installed on a supporting base surface, the longitudinal guide beam comprising a plurality of planks, each plank having a first end and a second end, the first end including a first toothed rack having a first pattern of grooves and projections at its bottom surface, and the second end including a second toothed rack having a second pattern of grooves and projections at its top surface, said second pattern being complementary to said first pattern, the first end of each plank being configured to interlock with the second end of an adjacent plank to form a unitary longitudinal guide beam; and
at least two transverse stop bars configured to be positioned onto and removably connected to the longitudinal guide beam, each transverse stop bar having a load bearing surface formed to incline at an acute angle with respect to a horizontal plane, each transverse stop bar further including an internal transverse groove configured to be placed onto said longitudinal guide beam so as to secure said transverse stop bars on said longitudinal guide beam,
wherein the longitudinal guide beam and transverse stop bars are made of a rubber-polymer composite material having a high coefficient of friction.

9. The system for storing cylindrical products according to claim 8, further comprising a plurality of said longitudinal guide beams, wherein said transverse stop bars are installed on at least two of said longitudinal guide beam, and wherein said longitudinal guide beams bearing most of a load of said cylindrical products and said transverse stop bars preventing said cylindrical products from rolling off said longitudinal guide beams.

10. The system for storing cylindrical products according to claim 9, wherein, when said transverse stop bars are installed on said longitudinal guide beams, said load bearing surfaces of an adjacent pair of transverse stop bars face each other so as to partially surround an outside surface of a cylindrical product placed onto said longitudinal guide beams.

11. The system for storing cylindrical products according to claim 9, wherein each of said longitudinal guide beams further includes a bottom surface, wherein each of said transverse stop bars further includes a bottom surface, and wherein, when said transverse stop bars are installed on said longitudinal guide beams, said bottom surfaces of said longitudinal guide beams and said bottom surfaces of said transverse stop bars form a unitary and leveled system bottom surface.

12. The system for storing cylindrical products according to claim 9, wherein said system is configured to support and store cylindrical products having a diameter of 530-1420 mm.

13. The system for storing cylindrical products according to claim 9, further comprising a tying element tying at least two of cylindrical products supported by said system.

14. The system for storing cylindrical products according to claim 8, wherein said high coefficient of friction is 0.38-0.4.

15. A system for storing rolled products, the system comprising:
at least two longitudinal guide beams configured to be installed on a supporting base surface, each longitudinal guide beam further comprising a first toothed rack having a first pattern of grooves and projections formed at a top surface of said longitudinal beam; and
at least two transverse stop bars configured to be positioned onto and removably connected to the longitudinal guide beams, each transverse stop bar having a load bearing surface formed to incline at an acute angle with respect to a horizontal plane, each transverse stop bar further including an internal transverse groove having a second toothed rack having a second pattern of grooves and projections formed at a top surface of said internal transverse groove, said second pattern being complementary to said first pattern, the second toothed rack being configured to interlock with the first toothed rack so as to secure said transverse stop bar on said longitudinal guide beam,
wherein the longitudinal guide beams and transverse stop bars are made of a rubber-polymer composite material having a high coefficient of friction.

16. The system for storing rolled products according to claim 15, wherein, when said transverse stop bars are installed on said longitudinal guide beams, a pair of adjacent transverse stop bars form a storage cavity for the rolled products to be placed into, said longitudinal guide beams within said storage cavity bearing most of a load of said rolled products and said transverse stop bars preventing said rolled products from rolling off said longitudinal guide beams.

17. The system for storing rolled products according to claim 16, wherein, when said transverse stop bars are installed on said longitudinal guide beams, said load bearing surfaces of said adjacent pair of transverse stop bars face each other so as to partially surround an outside surface of a rolled product placed into said storage cavity.

18. The system for storing rolled products according to claim 15, wherein each of said longitudinal guide beams further includes a bottom surface, wherein each of said transverse stop bars further includes a bottom surface, and wherein, when said transverse stop bars are installed on said longitudinal guide beams, said bottom surfaces of said longitudinal guide beams and said bottom surfaces of said transverse stop bars form a unitary and leveled system bottom surface.

19. The system for storing rolled products according to claim 15, wherein said system is configured to support and store rolled products having a diameter of 800-1500 mm.

20. The system for storing rolled products according to claim 15, wherein said high coefficient of friction is 0.38-0.4.
